(19) United States
(12) Patent Application Publication
(10) Pub. No.: US 2026/0175569 A1
(43) Pub. Date: Jun. 25, 2026

(54) PRINTING APPARATUS, DRIVING METHOD THEREOF, AND NON-TRANSITORY COMPUTER-READABLE STORAGE MEDIUM STORING PROGRAM

(71) Applicant: CANON KABUSHIKI KAISHA, Tokyo (JP)

(72) Inventors: TAKAHIRO DAIKOKU, Tokyo (JP); NOBORU HADA, Kanagawa (JP); TAKUYA TSUNEMI, Tokyo (JP)

(21) Appl. No.: 19/425,296

(22) Filed: Dec. 18, 2025

(30) Foreign Application Priority Data
Dec. 19, 2024 (JP) 2024-224303
Apr. 11, 2025 (JP) 2025-065780

(51) Int. Cl. B41J 2/045; B41J 2/175; B41J 2/18; B41J 2/20; B41J 2/21; B41J 29/377

(52) U.S. Cl. CPC B41J 2/0457; B41J 2/04536; B41J 2/04553; B41J 2/04561; B41J 2/04573; B41J 2/04581; B41J 2/04588; B41J 2/17596; B41J 2/18; B41J 2/20; B41J 2/2103; B41J 29/377

(57) ABSTRACT

A printing apparatus, comprising a printhead configured to perform print by discharging ink, and a circulation mechanism configured to circulate the ink in a circulation path of ink, which passes through the printhead, wherein the printing apparatus further comprises a specifying unit configured to specify a discharge speed of an ink droplet from the printhead, and a control unit configured to perform drive control of the circulation mechanism based on a specifying result of the specifying unit.

### BACKGROUND

### Field of the Technology

The present disclosure relates to a printing apparatus, a driving method thereof, and a non-transitory computer-readable storage medium storing a program.

### Description of the Related Art

Some printing apparatuses represented by an inkjet printer are configured to circulate ink to be supplied to a printhead (see Japanese Patent Laid-Open No. 2007-137023). When ink is circulated, the quality of the ink is maintained, and the quality of print can thus be improved.

In general, there is required a technique for further improving the quality of print by appropriately executing ink circulation.

### SUMMARY

The present disclosure provides a technique advantageous in further improving the quality of print.

One of the aspects of the present disclosure provides a printing apparatus comprising: a printhead configured to perform print by discharging ink; and a circulation mechanism configured to circulate the ink in a circulation path of ink, which passes through the printhead, wherein the printing apparatus further comprises: a specifying unit configured to specify a discharge speed of an ink droplet from the printhead; and a control unit configured to perform drive control of the circulation mechanism based on a specifying result of the specifying unit.

Features of the present disclosure will become apparent from the following description of embodiments with reference to the attached drawings. The following description of embodiments is given by way of example.

### BRIEF DESCRIPTION OF THE DRAWINGS

FIG. 1 is a perspective view showing the outer appearance of a printing apparatus according to an embodiment;

FIG. 2 is a perspective view showing a part of the internal structure of the printing apparatus;

FIG. 3 is a schematic view showing the configuration of a printhead;

FIG. 4 is a schematic view showing the ink path of the printhead;

FIG. 5A is a schematic view showing the configuration of the ink path of the printhead;

FIGS. 5B-a, 5B-b and 5B-c are schematic views each showing the structure of a pressure adjusting mechanism;

FIG. 5C is a schematic view showing a state of ink circulation by a circulation pump;

FIG. 6 is a block diagram showing a control system configured to implement ink circulation;

FIG. 7A is a view showing the relationship between the ink viscosity and the environmental temperature;

FIG. 7B is a view showing the relationship between the ink viscosity and the ink evaporation rate;

FIG. 8 is a view showing the relationship between the ink viscosity and the discharge speed of an ink droplet;

FIG. 9 is a schematic view for explaining an ink discharge state evaluation method;

FIG. 10 is a schematic view showing a configuration for specifying the discharge speed of an ink droplet;

FIG. 11A is a view showing the relationship between the ink viscosity and the circulation frequency;

FIG. 11B is a view showing the relationship between the ink viscosity and the drive voltage of a circulation actuator;

FIG. 11C is a view showing the relationship between the circulation frequency and the elapsed time;

FIGS. 12A and 12B are flowcharts showing an ink circulation control method;

FIG. 13 is a view showing the execution conditions of ink circulation control;

FIG. 14 is a block diagram showing a control system configured to implement ink circulation;

FIG. 15 is a view showing an example of the configuration of a voltage generation circuit;

FIG. 16 is a view showing an example of the configuration of a voltage generation circuit;

FIGS. 17A and 17B are flowcharts showing an ink circulation control method; and

FIGS. 18A and 18B are flowcharts showing an ink circulation control method.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### <Configuration of Printing Apparatus>

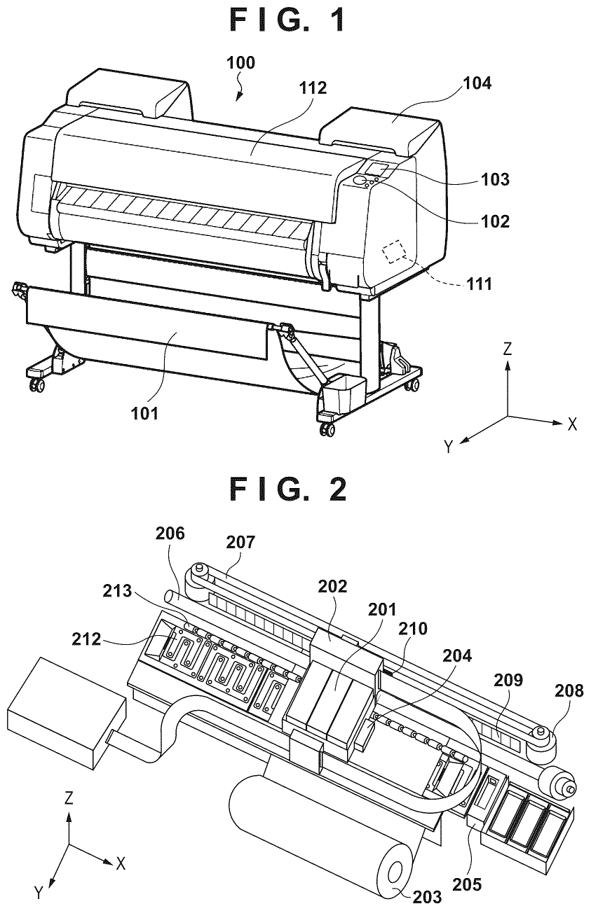

FIG. 1 is a perspective view showing the outer appearance of a printing apparatus 100. The printing apparatus 100 is an inkjet printer configured to implement print on a print medium 203 by discharging ink from a printhead 201 to be described later (see FIG. 2). The printing apparatus 100 includes a discharge guide 101, an operation panel 102, a display panel 103, an ink tank storage portion 104, and a temperature sensor 111.

The discharge guide 101 can guide the print medium 203 printed and discharged to the outside of the apparatus and stack it. The operation panel 102 can input, by a user operation, setting information necessary for execution of print. The display panel 103 can display notification information to the user. The ink tank storage portion 104 can store ink tanks containing inks of a plurality of colors (in this embodiment, four colors including black (Bk), cyan (Cy), magenta (Ma), and yellow (Ye)), respectively. The temperature sensor 111 can detect the temperature (environmental temperature) under a print environment, and is arranged on the periphery of the printhead 201 (to be described later) in this embodiment.

The printing apparatus 100 further includes a cover 112 that can be opened/closed with respect to the apparatus main body. The user can access the inside of the apparatus main body by opening the cover 112, and can perform, for example, maintenance of the printing apparatus 100, setting of the print medium 203, and the like.

Here, print indicates forming an image by discharging ink onto the print medium 203. The concept of an image includes characters, numbers, symbols, graphics, photos, and the like, and whether these are visible or not is not an issue. Ink is typically a liquid containing dyes or pigments, and may be a colorless transparent reaction liquid, and these may simply comprehensively be expressed as a liquid. From this viewpoint, the printing apparatus 100 may be expressed as a liquid discharge apparatus (similarly, the printhead 201 may be expressed as a liquid discharge head). Note that the printing apparatus 100 may be a copying machine that has a print function as the main function and further has additional functions such as a copy function, a scanner function, and a facsimile function as sub functions.

FIG. 2 is a perspective view showing a part of the internal structure of the printing apparatus 100. The printing apparatus 100 includes the printhead 201, a carriage 202, a guide rail 206, a conveyor belt 207, a carriage motor 208, a platen 212, and a conveyance roller 213.

The carriage 202 is supported such that it can slide along the guide rail 206 extended in the X direction, and can reciprocally move in the X direction by receiving power of the carriage motor 208 via the conveyor belt 207. The printhead 201 is mounted on the carriage 202 and can scan in the X direction. The platen 212 supports, from below, the print medium 203 conveyed in the Y direction by the conveyance roller 213. With this configuration, the printhead 201 can execute print by performing scanning in the X direction with respect to the print medium 203 conveyed in the Y direction.

Print for the print medium 203 is implemented by alternately performing an operation (intermittent conveyance) of conveying the print medium 203 in the Y direction by a predetermined amount by the conveyance roller 213 and then suppressing the conveyance and an operation (print scan) of performing print by the printhead 201 scanning the X direction during this. The printhead 201 is also expressed as a serial head. As another embodiment, the printhead 201 may be a line head capable of printing, at once, the whole widthwise-direction (X-direction) region of the print medium 203 conveyed in the Y direction.

The print medium 203 need only be a medium (typically, a paper material) on which an image can be formed by ink discharged from the printhead 201. A roll sheet is shown here, but it may be a cut sheet cut into a predetermined size.

As an example, latex ink is used as the ink. In this case, water is evaporated by heating, a latex resin is melted and mixed with a pigment, and a film is formed and cured, thereby forming an image on the print medium 203. The solvent ratio and the ink viscosity of the latex ink are generally higher than those of water-based ink.

The printing apparatus 100 further includes a linear scale 209 and an encoder sensor 210. The linear scale 209 is extended along the guide rail 206, and the encoder sensor 210 can specify the position of the carriage 202 by detecting the linear scale 209.

The printing apparatus 100 further includes a distance detection sensor 204 and a discharge speed detection unit 205. The distance detection sensor 204 is installed on the printhead 201 and can detect the distance between the printhead 201 and the print medium 203. As the distance detection sensor 204, an optical sensor including a light emitting element (not shown) that irradiates the print medium 203 with light and a light receiving element (not shown) that receives the light reflected by the print medium 203 is typically used, and the distance can be measured based on the signal values thereof. As will be described later in detail, the discharge speed detection unit 205 can detect the discharge speed of an ink droplet discharged from the printhead 201.

### <Ink Circulation>

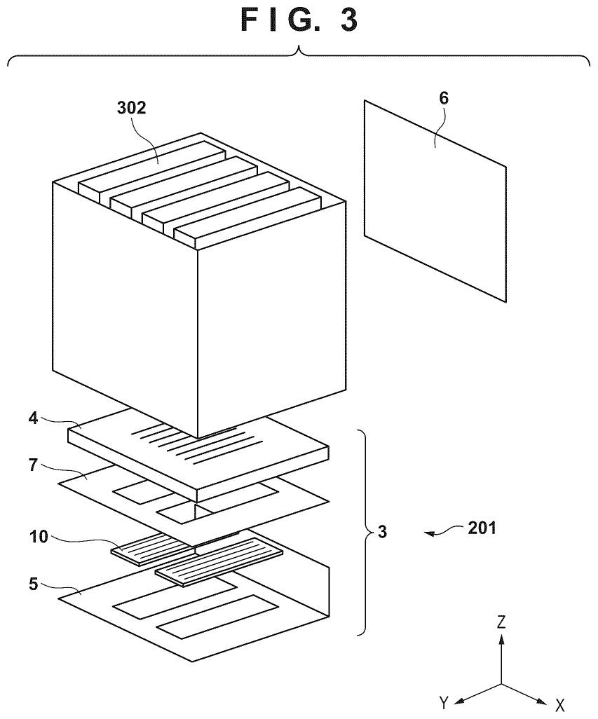

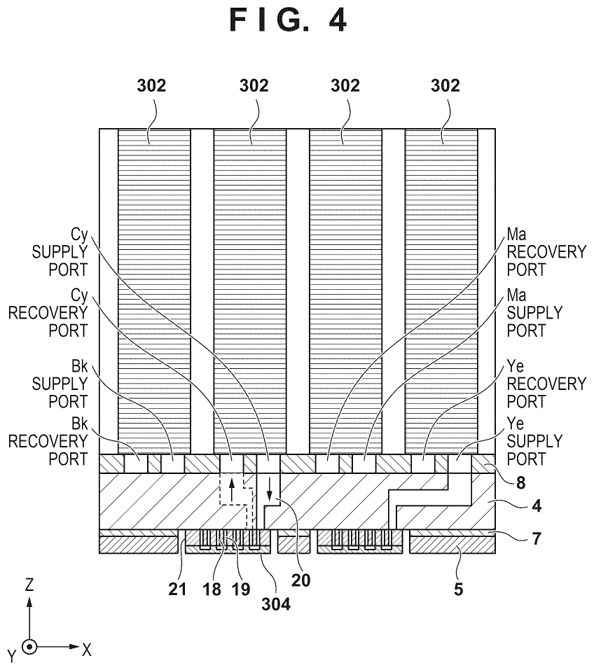

FIG. 3 is a schematic view showing the configuration of the printhead 201. FIG. 4 is a schematic view showing the ink path of the printhead 201 (arrows in FIG. 4 indicate the directions of ink flow).

The printhead 201 includes a discharge unit 3 that discharges ink and a circulation unit 302 configured to circulate the ink. Although not illustrated here, ink supply paths and connector insertion ports are formed such that the color inks can be supplied to the printhead 201. In this embodiment, the discharge unit 3 includes two element substrates 10, a path member 4, a support member 7, an electric wiring member 5, and an electric contact substrate 6.

The element substrate 10 is formed by arraying a plurality of electrothermal transducers on one surface of a semiconductor substrate such as a silicon substrate, and each electrothermal transducer can generate energy for discharging ink by energization. The electrothermal transducer can also be expressed as a resistive heating element or a heater element and may be expressed as a print element or a liquid discharge element.

On the one surface (the surface on which the electrothermal transducers are arrayed) of the semiconductor substrate, a plate material in which ink paths and pressure chambers are formed in correspondence with the electrothermal transducers is arranged. The pressure chamber is connected to the ink path, and includes, near the electrothermal transducer, a nozzle 304 provided to discharge ink.

On the other surface (the surface on the opposite side of the surface on which the electrothermal transducers are arrayed) of the semiconductor substrate, individual supply paths 19 each configured to supply ink by making it flow into each ink path, and individual recovery paths 18 each configured to recover ink flowing out from each ink path.

The path member 4 includes a supply path 20 and a recovery path 21, and the supply path 20 and the recovery path 21 are connected to the individual supply path 19 and the individual recovery path 18, respectively, on the upper side of the element substrate 10. The support member 7 includes openings at positions corresponding to the element substrates 10 and is arranged while being fixed with respect to the path member 4. In addition, the support member 7 supports the electric wiring member 5 such that it can be connected to the element substrates 10. The electric wiring member 5 can supply a drive signal for driving the electrothermal transducers to the element substrates 10.

In FIG. 4, a plurality of nozzles 304 are arrayed in the depth direction (Y direction) to form a nozzle array, and a plurality of individual supply paths 19 and a plurality of individual recovery paths 18 are arrayed along the nozzle array. The individual supply path 19 is connected to the supply path 20 formed at a certain position of the path member 4 and connected to the circulation unit 302 of a corresponding color via a joint member 8 with a supply port. Similarly, the individual recovery path 18 is connected to the recovery path 21 formed at another position of the path member 4 and connected to the circulation unit 302 of a corresponding color via the joint member 8 with a recovery port.

With this configuration, the ink of each color is supplied from the circulation unit 302 to the nozzle 304 while sequentially passing through the supply port of the joint member 8, the supply path 20, and the individual supply path 19. The ink supplied to the nozzle 304 sequentially passes through the individual recovery path 18, the recovery path 21, and the recovery port of the joint member 8 and is recovered by the circulation unit 302. Ink circulation is thus implemented.

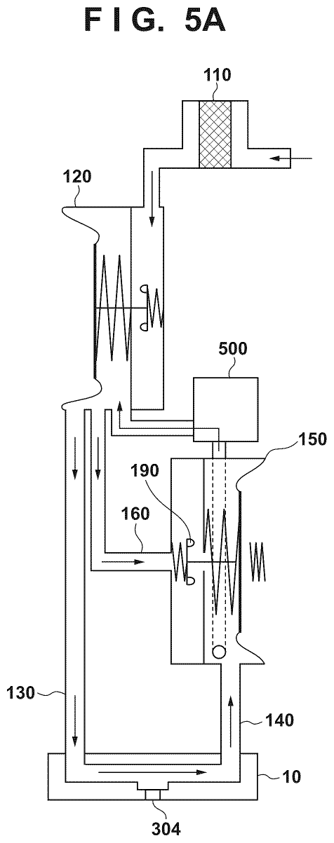

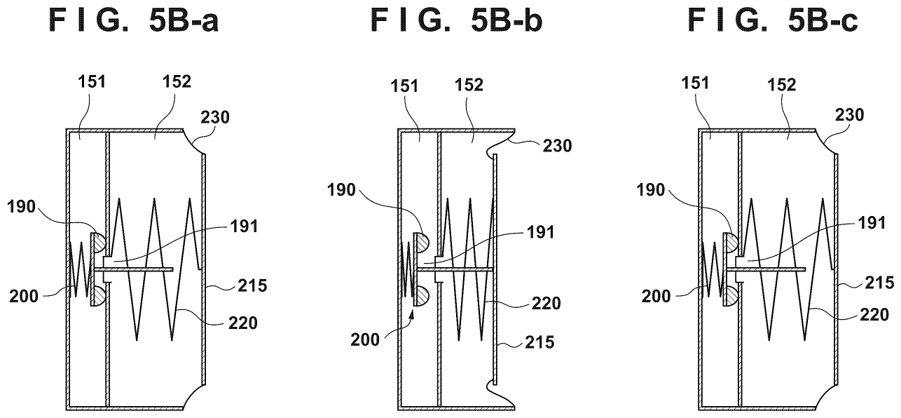

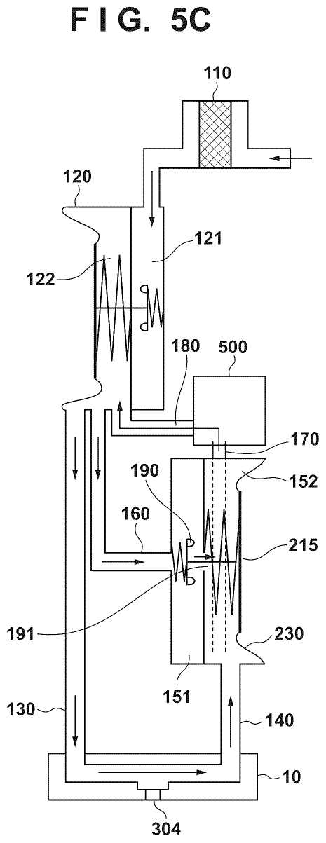

FIG. 5A is a schematic view showing the configuration of the ink path for one color in the printhead 201 from another aspect (arrows in FIG. 5A indicate the directions of ink flow). The printhead 201 includes a filter 110, a first pressure adjusting mechanism 120, a supply path 130, a recovery path 140, a second pressure adjusting mechanism 150, a bypass path 160, and a circulation pump 500.

Ink supplied from an ink tank in the ink tank storage portion 104 is pressure-fed by a pressurization pump (not shown), passes through the filter 110, and is depressurized and supplied to a liquid chamber (first liquid chamber) in the pressure adjusting mechanism 120. The depressurized ink is supplied to the element substrate 10 through the supply path 130 and supplied to a pressure chamber in which the nozzle 304 is provided. If the above-described electrothermal transducer is driven, a part of the ink in the pressure chamber is discharged from the nozzle 304, and the remaining part (all in the case where the electrothermal transducer is not driven) is supplied to a liquid chamber (second liquid chamber) in the pressure adjusting mechanism 150 through the recovery path 140. The circulation pump 500 pressure-feeds the ink in the liquid chamber of the pressure adjusting mechanism 150 and returns it to the liquid chamber in the pressure adjusting mechanism 120. The circulation path of ink is thus formed.

Note that the supply path 130 corresponds to the supply path 20 and the supply port of the joint member 8, and the recovery path 140 corresponds to the recovery path 21 and the recovery port of the joint member 8.

FIG. 5B-a is a schematic view showing the structure of the pressure adjusting mechanism 150. The pressure adjusting mechanism 150 includes a valve chamber 151, a pressure control chamber 152, and a communicating port 191 that makes these communicate. A valve 190 capable of opening/closing the communicating port 191 is provided in the valve chamber 151. The valve 190 is at least partially formed by an elastic member and biased by a valve spring 200 in a direction to close the communicating port 191.

A pressure plate 215 and a flexible member 230 are arranged on the outer side surface of the pressure control chamber 152, and the pressure plate 215 can be displaced by the flexible member 230. This configuration can be produced by heat-welding the pressure plate 215 formed by a resin molded component to the flexible member 230 formed by a resin film.

The pressure plate 215 and the flexible member 230 are biased to the outer side (in a direction in which the capacity of the pressure control chamber 152 increases) by a pressure adjusting spring 220. If the negative pressure in the pressure control chamber 152 increases, the pressure plate 215 is displaced in a direction in which the capacity of the pressure control chamber 152 decreases. If the pressure in the pressure control chamber 152 reaches a predetermined negative pressure, the pressure plate 215 abuts against the distal end of the valve 190. If the negative pressure further increases, as shown in FIG. 5B-b, the pressure plate 215 pushes the valve 190 in, and the communicating port 191 is set in an open state.

The pressure in the valve chamber 151 is controlled such that it becomes higher than the pressure in the pressure control chamber 152. Thus, when the communicating port 191 is in the open state, ink flows from the valve chamber 151 into the pressure control chamber 152. Along with this, as shown in FIG. 5B-c, the pressure plate 215 is displaced in a direction in which the capacity of the pressure control chamber 152 increases, and the communicating port 191 is set in a closed state. Thus, since the ink flows from the valve chamber 151 into the pressure control chamber 152 via the communicating port 191 at a predetermined negative pressure or more, and the negative pressure does not increase any more, the pressure in the pressure control chamber 152 can be controlled within a predetermined range.

The elements of the pressure adjusting mechanism 150 and their functions described with reference to FIGS. 5B-a to 5B-c also apply to the pressure adjusting mechanism 120.

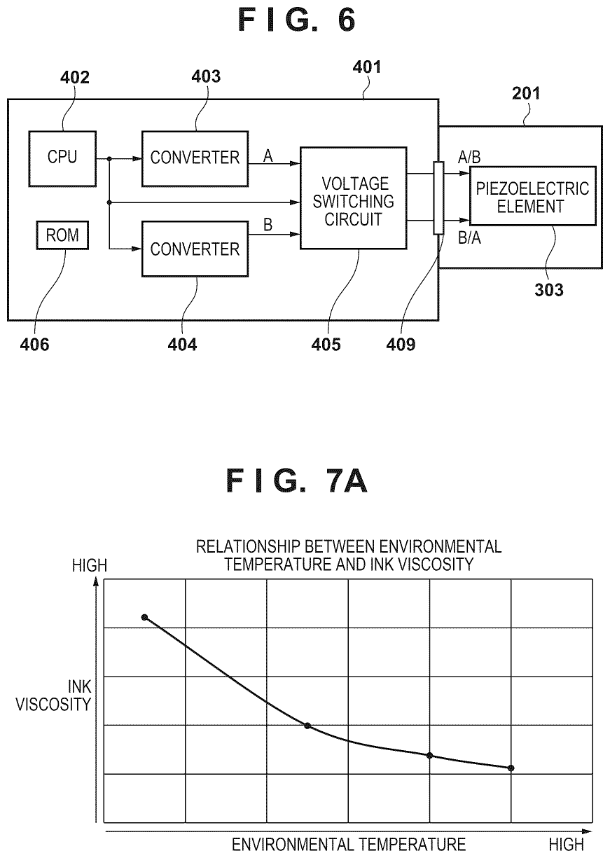

The circulation pump 500 is provided with a piezoelectric element (a piezoelectric element 303 in FIG. 6 to be described later) and a diaphragm. When a voltage is applied to the piezoelectric element, an electrostrictive effect occurs, and the diaphragm can thus be vibrated. The ink in the printhead 201 is thus circulated, the freshness of the ink near the nozzle 304 is maintained and, for example, an increase of the viscosity of the ink can be prevented.

FIG. 5C is a schematic view showing the state of ink circulation by the circulation pump 500. In FIG. 5C, a valve chamber 121 and a pressure control chamber 122 of the pressure adjusting mechanism 120 correspond to the valve chamber 151 and the pressure control chamber 152 of the pressure adjusting mechanism 150, respectively. Ink in the pressure control chamber 122 is supplied to the supply path 130 and the bypass path 160.

The ink supplied to the supply path 130 is supplied to the element substrate 10 and discharged from the nozzle 304. Alternatively, if the ink is not discharged from the nozzle 304, it passes through the recovery path 140 and returns to the pressure control chamber 152.

On the other hand, the ink supplied to the bypass path 160 is supplied to the pressure control chamber 152 via the valve chamber 151. The ink supplied to the pressure control chamber 152 is supplied to the circulation pump 500 via a pump inlet path 170, and then supplied to the pressure control chamber 122 via a pump outlet path 180. The pressure in the pressure control chamber 122 is controlled such that it becomes higher than the pressure in the pressure control chamber 152. Thus, the ink in the pressure control chamber 122 is supplied to the supply path 130.

The above-described paths configured to implement such ink circulation can collectively be expressed as a circulation path, and the above-described mechanisms configured to implement the ink circulation can collectively be expressed as a circulation mechanism.

FIG. 6 is a block diagram showing a control system configured to implement the above-described ink circulation. The printing apparatus 100 further includes a control substrate 401. The control substrate 401 includes a CPU 402, converters 403 and 404, a voltage switching circuit 405, and a ROM 406. A DC-DC converter can be used for each of the converters 403 and 404.

In the printhead 201, the piezoelectric element 303 is connected to the control substrate 401 via an electric connection terminal 409, and outputs A and B from the converters 403 and 404, respectively, are input to the piezoelectric element 303 while being switched by the voltage switching circuit 405. The CPU 402 controls the resistance values in the circuits forming the converters 403 and 404 and also controls a switch element such as a MOS transistor in the voltage switching circuit 405. This can adjust the value, frequency, phase, pulse width, and the times (periods, timings, and the like) of the rise edge and fall edge of a voltage to be input to the piezoelectric element 303. Details of switching by the voltage switching circuit 405 will be described later.

The ROM 406 functions as a storage unit that stores information associated with execution of print, such as an environmental temperature and an ink circulation time, and the CPU 402 can control the piezoelectric element 303 based on the information. As the ROM 406, a nonvolatile memory such as a flash memory can be used.

### <Viscosity of Ink>

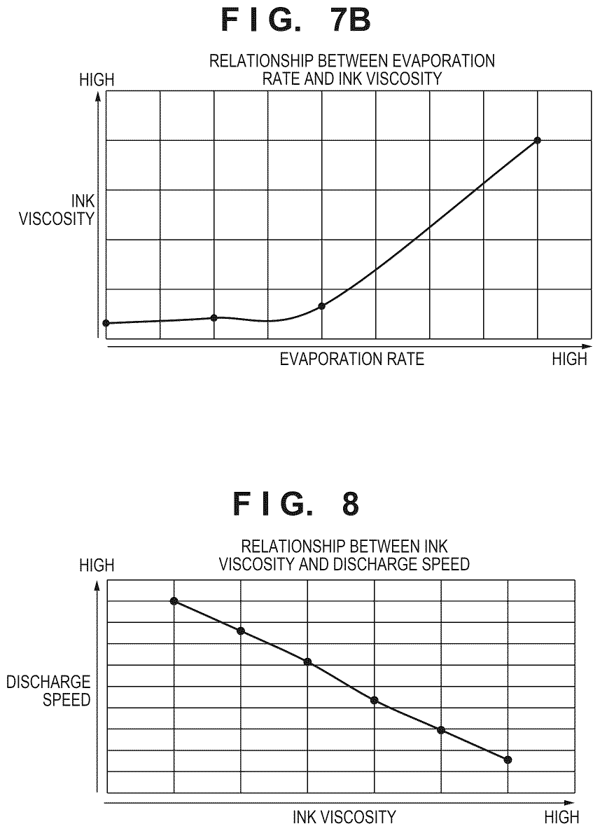

FIG. 7A shows the relationship between the viscosity of ink discharged from the nozzle 304 (the viscosity of ink on the periphery of the nozzle 304) and the environmental temperature (the temperature on the periphery of the nozzle 304). As is apparent from FIG. 7A, when the environmental temperature is low, the ink viscosity is high.

FIG. 7B shows the relationship between the ink viscosity and the ink evaporation rate. When the environmental temperature rises, water readily evaporates from the nozzle 304, and the ink evaporation rate becomes high. When water evaporates from the nozzle 304, the ink viscosity becomes high.

Also, if the time (non-circulation time) in which ink circulation is suppressed is long, the ink viscosity rises because of sedimentation of ink components.

That is, the ink viscosity changes due to various factors, and it is therefore difficult to estimate it based on a single factor.

FIG. 8 shows the relationship between the ink viscosity and the speed (discharge speed) of an ink droplet discharged from the nozzle 304. In a case where the ink discharge conditions other than the ink viscosity do not change (for example, if ink is discharged from the same nozzle 304 by applying the same energy to the ink by driving of the electrothermal transducer), if the ink viscosity is high, the discharge speed of an ink droplet lowers.

Also, as is apparent from FIG. 8, the ink viscosity and the discharge speed of an ink droplet have a correlation relationship. That is, the ink viscosity on the periphery of the nozzle 304 can be specified based on the discharge speed of an ink droplet.

### <Specifying of Discharge Speed of Ink>

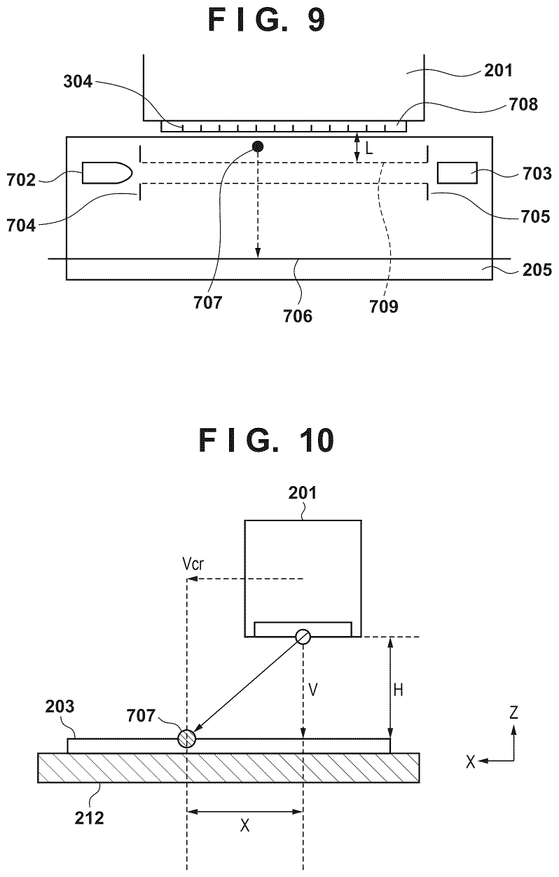

FIG. 9 is a schematic view for explaining an ink discharge state evaluation method by the discharge speed detection unit 205 and shows a state in which an orifice array 708 formed by arraying the plurality of nozzles 304 is viewed in the X direction. In this embodiment, the discharge speed detection unit 205 includes a light emitting element 702, a light receiving element 703, a light emitting element aperture 704, a light receiving element aperture 705, and an ink absorber 706. The ink absorber 706 is configured to absorb an ink droplet 707 discharged from the nozzle 304 and, for example, a porous member such as sponge can be used.

The light emitting element 702 and the light receiving element 703 are arranged such that the ink droplet 707 discharged from the nozzle 304 shields a light beam 709. As the light emitting element 702, for example, an infrared light LED whose directivity is relatively narrow is used. When detecting the discharge speed of the ink droplet 707, a voltage (for example, 5 V) is applied to the light emitting element 702. The light beam 709 from the light emitting element 702 enters the light receiving element 703 and is detected. As the light receiving element 703, for example, a photodiode with high sensitivity in the infrared light region is used.

The printhead 201 is scanned up to above the discharge speed detection unit 205 when detecting the discharge speed, and after that, the nozzles 304 are sequentially driven. The ink droplet 707 discharged from the nozzle 304 shields the light beam 709 (passes through the light beam 709), lands on the ink absorber 706, and is absorbed.

Here, let L be the distance from the nozzle 304 to the light beam 709. Also, let T be the time difference between the drive signal of the nozzle 304 when discharging the ink droplet 707 and the detection signal of the light receiving element 703 when the ink droplet 707 shields the light beam 709 (for example, the time difference between the rise edge of the drive signal and the rise edge of the detection signal). In this case, a discharge speed V of the ink droplet 707 is calculated by

V=L/T

In the example shown in FIG. 9, the discharge speed of the ink droplet 707 is calculated using an optical sensor (the light emitting element 702 and the light receiving element 703) that detects the shielding of the light beam 709 by the ink droplet 707, but another method may be employed. For example, calculation of the discharge speed may be implemented by an electrostatic sensor that detects a change of a voltage that may be caused by landing of the ink droplet 707. If the discharge speed detection unit 205 or another detection means is not used, for example, a predetermined pattern may be printed, and the discharge speed may be calculated by measuring the position deviation amount.

FIG. 10 is a schematic view showing another configuration for specifying the discharge speed of the ink droplet 707. Letting H be the distance between the printhead 201 and the print medium 203, the distance H is detected by the distance detection sensor 204. In addition, let Vcr be the scan speed (moving speed) of the printhead 201 in the X direction, and V be the discharge speed of the ink droplet 707.

As an example, the landing position alignment of the ink droplet 707 is performed by printing a predetermined pattern (position adjustment pattern) on the print medium 203. For example, for the ink droplet 707 discharged in the forward direction (for example, the +X direction) and the ink droplet 707 discharged in the backward direction (for example, the −X direction), their discharge timings are adjusted. At this time, a distance X of the position deviation from the timing at which the ink droplet 707 is discharged in the forward direction to the timing at which the ink droplet 707 lands on the print medium 203 is expressed as

X=(H/V)×Vcr

Hence, the discharge speed V of the ink droplet 707 is calculated as

V=(H/X)×Vcr

In this way, the discharge speed V can be calculated based on the distance H detected by the distance detection sensor 204 and the distance X specified by the position adjustment pattern.

Note that in the above-described example, a mode in which the discharge speed V of the ink droplet 707 is indirectly specified by calculation has been exemplified, but the discharge speed V may directly be specified by measurement.

### <Characteristic of Ink Viscosity>

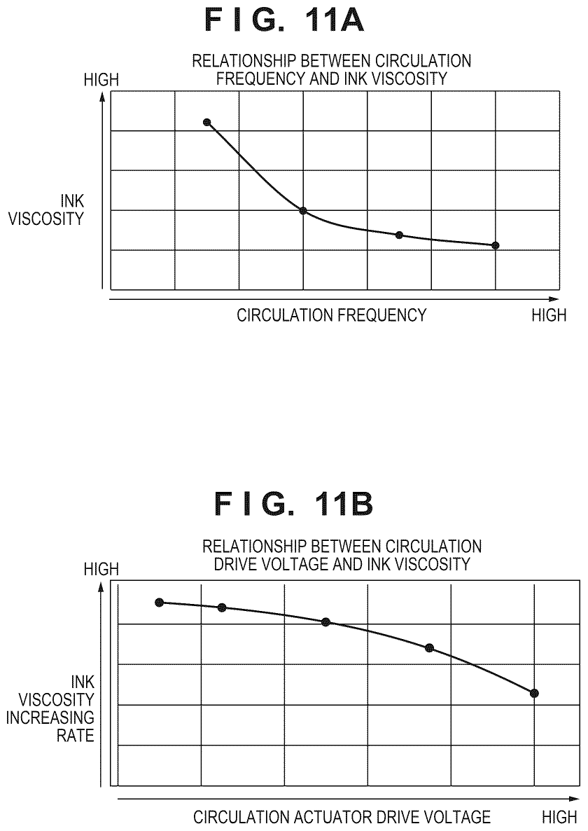

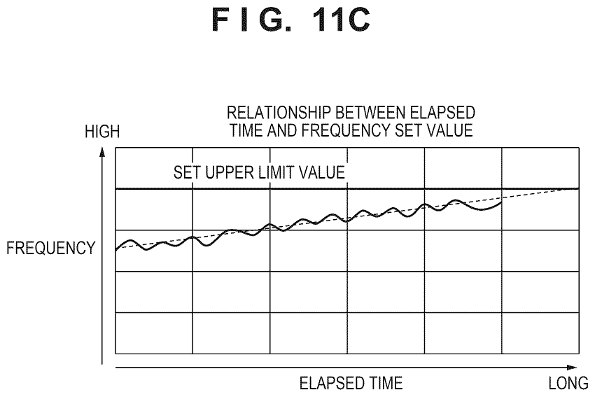

FIG. 11A shows the relationship between the ink viscosity and a frequency for ink circulation (to be referred to as a circulation frequency hereinafter). The circulation frequency corresponds to the drive frequency of the circulation pump 500 (that is, a drive force for circulating ink) and, in this embodiment, corresponds to the drive frequency of the piezoelectric element 303 (that is, the vibration frequency of the diaphragm per unit time). The circulation frequency may be expressed as a stirring frequency because it is a frequency for stirring ink. When the circulation frequency becomes high, the ink circulation amount increases, and the ink is further stirred. Hence, an increase of the viscosity of the ink on the periphery of the nozzle 304 is suppressed.

Here, as described with reference to FIGS. 7A, 7B, and 8, if the ink viscosity changes, the discharge speed of the ink droplet 707 also changes. As is apparent from FIG. 11A, the ink viscosity on the periphery of the nozzle 304, that is, the discharge speed of the ink droplet 707 can be controlled by the circulation frequency and can be maintained constant.

FIG. 11B shows the relationship between the ink viscosity and the drive voltage of a circulation actuator formed by the piezoelectric element 303 and the diaphragm (the voltage value input to the piezoelectric element 303). When the drive voltage increases, and the vibration energy of the piezoelectric element 303 becomes large, the ink is further stirred. For this reason, the increase rate of the ink viscosity is suppressed, and the ink viscosity on the periphery of the nozzle 304 lowers. That is, the ink viscosity on the periphery of the nozzle 304, that is, the discharge speed of the ink droplet 707 can also be controlled by adjusting the drive voltage of the circulation actuator and can be maintained constant.

### <Circulation Actuator>

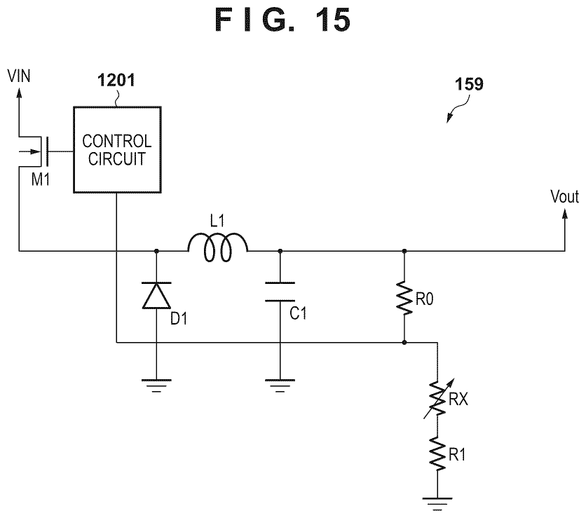

FIG. 15 shows an example of the configuration of a voltage generation circuit 159 capable of changing the drive voltage of the circulation actuator (the voltage value input to the piezoelectric element 303), and the voltage generation circuit 159 corresponds to each of the converters 403 and 404 shown in FIG. 6. The voltage generation circuit 159 includes a resistance element R0, a resistance element R1, a potentiometer (variable resistor) RX, a MOS transistor M1, an inductor L1, a capacitor C1, a Schottky barrier diode D1, and a control circuit 1201.

The control circuit 1201 feeds back a divided voltage concerning an output voltage Vout by the resistance elements R0 and R1 and the potentiometer RX as a reference voltage to the MOS transistor M1, thereby controlling the gate of the MOS transistor M1. By changing the resistance value of the potentiometer RX, the output voltage Vout can be changed to a value according to the resistance ratio of the resistance elements R0 and R1 and the potentiometer RX.

For example, if the discharge speed of the ink droplet 707 falls outside the reference range, the resistance value of the potentiometer RX is changed. That is, the output voltage Vout can be made high by decreasing the resistance value of the potentiometer RX, and the output voltage Vout can be made low by increasing the resistance value of the potentiometer RX. Thus, the ink viscosity can be adjusted to a desired viscosity, and the discharge speed of the ink droplet 707 can be set within the reference range.

Note that the change of the resistance value of the potentiometer RX may be implemented by an electric signal but may be implemented manually.

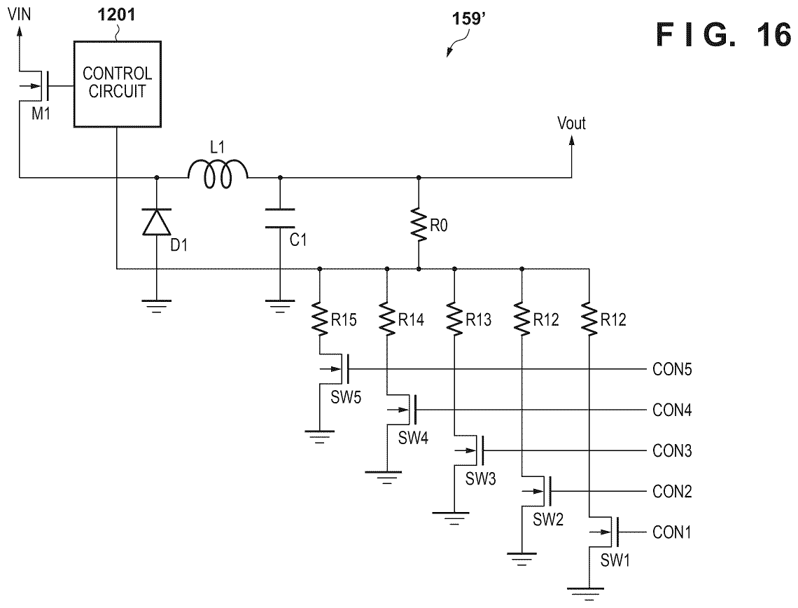

FIG. 16 shows another example of the configuration of a voltage generation circuit 159′ capable of changing the drive voltage of the circulation actuator, like FIG. 15. The voltage generation circuit 159′ includes resistance elements R11 to R15 and switch elements SW1 to SW5, in place of the resistance element R1 and the potentiometer RX described above. The resistance elements R11 to R15 have different resistance values and, in this example, the resistance value becomes large in this order (if these resistance values are expressed as R11 to R15, R11<R12<R13<R1 <R15 holds).

The switch elements SW1 to SW5 are directly connected to the resistance elements R11 to R15, respectively, and controlled by control signals CON1 to CON5 from the CPU 402, respectively. Here, by the control signals CON1 to CON5, one of the switch elements SW1 to SW5 is controlled to a conductive state (ON state), and the remaining switch elements are controlled to a non-conductive state (OFF state).

As an example, when the switch element SW1 is in the conductive state (the remaining switch elements (SW2 to SW5) are in the non-conductive state), the divided voltage concerning the output voltage Vout by the resistance elements R0 and R11 is fed back as a reference voltage to the MOS transistor M1. As another example, when the switch element SW2 is in the conductive state (the remaining switch elements (SW1 and SW3 to SW5) are in the non-conductive state), the divided voltage concerning the output voltage Vout by the resistance elements R0 and R12 is fed back as a reference voltage to the MOS transistor M1.

According to this configuration, the output voltage Vout can be changed depending on which one of the switch elements SW1 to SW5 is set to the conductive state. Hence, adjustment of the ink viscosity and adjustment of the discharge speed of the ink droplet 707 associated with that can be implemented by an electric signal.

Here, the outputs A and B from the converters 403 and 404 (see FIG. 6) may be a positive (plus) value and a negative (minus) value. The voltage value input to the piezoelectric element 303 (the difference between the voltage value input to one terminal of the piezoelectric element 303 and the voltage value input to the other terminal) can thus be made large.

A known configuration need only be employed as the voltage switching circuit 405 and, as an example, an H bridge circuit can be employed. In this case, the current amounts to be supplied to the gates of FET components (transistors) on the source side and the sink side of the H bridge circuit are changed, thereby controlling the times of the rise edge and the fall edge for the waveform of the voltage to be input to the piezoelectric element 303. For example, the times of the rise edge and the fall edge can be made early by increasing the current amounts to the gates of the FET components, and the times of the rise edge and the fall edge can be made late by decreasing the current amounts. Thus, if the discharge speed of the ink droplet 707 falls outside the reference range, the times of the rise edge and the fall edge are controlled. Thus, the ink viscosity can be adjusted to a desired viscosity, and the discharge speed of the ink droplet 707 can be set within the reference range.

### <Ink Circulation Control>

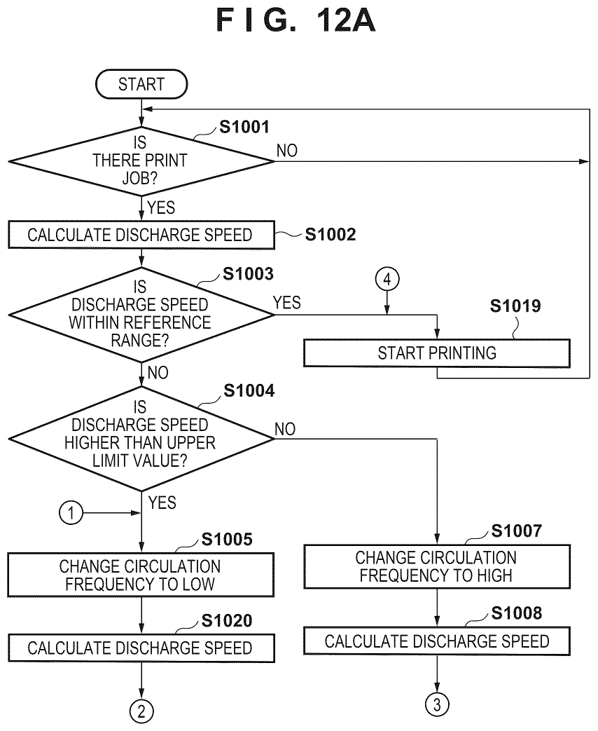

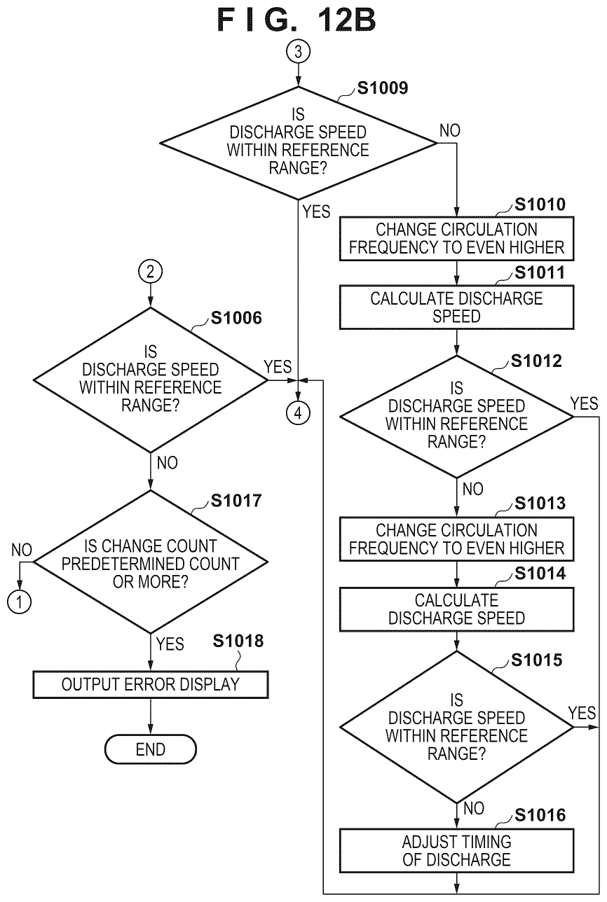

FIGS. 12A and 12B are flowcharts showing an ink circulation control method according to this embodiment. As the outline of this flowchart, the circulation frequency is changed to stabilize the discharge speed of the ink droplet 707 such that the discharge speed of the ink droplet 707 falls within the reference range, and steps for implementing these can be executed by the control substrate 401 (mainly the CPU 402).

In response to acceptance of a print job by the printing apparatus 100 in step S1001 (to be simply referred to as “S1001” hereinafter, and this also applies to remaining steps to be described later), in S1002, the discharge speed of the ink droplet 707 is calculated. In this embodiment, this calculation is assumed to be performed using the discharge speed detection unit 205 (see FIG. 9). Note that the print job can include a command for instructing execution of print, image data that is a print target, setting information necessary for execution of print, and the like.

In S1003, it is determined whether the discharge speed of the ink droplet 707 calculated in S1002 falls within the reference range. If the discharge speed falls within the reference range, the process advances to S1019, and otherwise, the process advances to S1004. Note that in S1019, assuming that ink circulation control is appropriately performed, print based on the print job in S1001 is started.

In S1004, it is determined whether the discharge speed of the ink droplet 707 is higher (faster) than the upper limit value of the reference range or lower (slower) than the lower limit value of the reference range. If the discharge speed is higher than the upper limit value, the process advances to S1005. If the discharge speed is lower than the lower limit value, the process advances to S1007.

In S1005, assuming that the energy used for ink circulation is excessive, the circulation frequency is changed to a lower frequency (0.9 times in this embodiment) and, in S1020, the discharge speed of the ink droplet 707 is calculated. After that, in S1006, it is determined, in accordance with the same procedure as in S1003, whether the discharge speed of the ink droplet 707 falls within the reference range. If the discharge speed falls within the reference range, the process advances to S1019, and otherwise, the process advances to S1017. In S1017, the count of the change to a lower circulation frequency (S1005) is determined. If the count of the change is a predetermined count (four times in this embodiment) or more, the process advances to S1018, and otherwise, the process returns to S1005. In S1018, determining that the discharge speed cannot be set within the reference range by the change to the lower circulation frequency, for example, error display is output to the display panel 103, thereby notifying the user that the printing apparatus 100 needs maintenance.

In this way, if the discharge speed of the ink droplet 707 is higher than the upper limit value of the reference range, the circulation frequency is changed to a lower one only a predetermined number of times, thereby setting the discharge speed within the reference range and starting print. If the discharge speed cannot be set within the reference range by changing the circulation frequency a predetermined number of times, error display is output.

In S1007, assuming that the energy used for ink circulation is short, the circulation frequency is changed to a higher frequency (1.1 times in this embodiment) and, in S1008, the discharge speed of the ink droplet 707 is calculated. After that, in S1009, it is determined, in accordance with the same procedure as in S1003, whether the discharge speed of the ink droplet 707 falls within the reference range. If the discharge speed falls within the reference range, the process advances to S1019, and otherwise, the process advances to S1010.

In S1010, assuming that the energy used for ink circulation is still short, the circulation frequency is further changed to a higher frequency (further 1.1 times in this embodiment) and, in S1011, the discharge speed of the ink droplet 707 is calculated. After that, in S1012, it is determined, in accordance with the same procedure as in S1003, whether the discharge speed of the ink droplet 707 falls within the reference range. If the discharge speed falls within the reference range, the process advances to S1019, and otherwise, the process advances to S1013.

In S1013, the circulation frequency is further changed to a higher frequency (further 1.2 times in this embodiment) and, in S 1014, the discharge speed of the ink droplet 707 is calculated. After that, in S1015, it is determined, in accordance with the same procedure as in S1003, whether the discharge speed of the ink droplet 707 falls within the reference range. If the discharge speed falls within the reference range, the process advances to S1019, and otherwise, the process advances to S1016.

If the process advances to S1016, it is considered that the discharge speed cannot fall within the reference range because of aging of the printhead 201 itself (not the shortage of the energy for ink circulation). For this reason, in S1016, discharge timing adjustment for adjusting the timing of discharge of the ink droplet 707 is performed. After that, the process advances to S1019 (start of print based on the print job). The discharge timing adjustment need only be performed using a known method and, this is typically performed based on the position deviation amount of the pattern printed for each of the forward direction and the backward direction on a color basis. Note that if the discharge speed of the ink droplet 707 is less than an allowable value (a value lower than the lower limit value), error display may be output, like S1018.

The change of the low/high circulation frequency can be implemented by changing the voltages (outputs A and B) input to the piezoelectric element 303 (see FIG. 6). The configuration of the voltage switching circuit 405 can be implemented by a known circuit configuration using a selector and the like, but may be changed without departing from its scope.

According to the ink circulation control as described above, it is determined for each color whether the discharge speed of the ink droplet 707 falls within the reference range. If the discharge speed does not fall within the reference range, the circulation frequency is adjusted or controlled to a frequency at which the discharge speed falls within the reference range. Hence, according to this embodiment, the discharge speed of the ink droplet 707 is stabilized such that it falls within the reference range, and the quality of print can be improved. This also applies to a case where ink of a different type is used (for example, a case where the ink composition is changed).

In this embodiment, the circulation frequency is increased/decreased at a predetermined magnification (0.9 times, 1.1 times, or 1.2 times in this embodiment). The magnification may be another value, or instead of increasing/decreasing the circulation frequency based on the magnification, it may be changed to a fixed value.

If the circulation pump 500 is driven by Pulse Width Modulation (PWM) control, the duty cycle of the drive signal of the circulation pump 500 may be changed in place of/in addition to the change of the circulation frequency. That is, a means for controlling the drive force for circulating ink or a means for setting the discharge speed of the ink droplet 707 within the reference range may be changed without departing from its scope based on the configuration of the circulation mechanism.

The above-described circulation frequency adjustment may be performed such that the discharge speed of the ink droplet 707 for one color falls within the reference range and, after that, the adjusted circulation frequency may be applied to the remaining colors. If the ink composition changes between the colors, the adjustment of the circulation frequency may be performed for each color (individually). This also applies to the increase/decrease of the magnification (0.9 times, 1.1 times, or 1.2 times in this embodiment), and the increase/decrease amount may be set to different values between the colors.

In the above-described flowchart, other changes exemplified in this specification may be added to obtain the same effect as described above.

As an example, in S1005, S1007, S1010, and S1013, the voltage to be input to the piezoelectric element 303 may be adjusted by controlling the switch elements SW1 to SW5 exemplified in FIG. 16. For example, in the initial state, the switch element SW2 is set to the conductive state. At this time, the switch element SW1 can be set to the conductive state in S1005, the switch element SW3 can be set to the conductive state in S1007, the switch element SW4 can be set to the conductive state in S1010, and the switch element SW5 can be set to the conductive state in S1013.

As another example, the times of the rise edge and the fall edge of the waveform of the voltage to be input to the piezoelectric element 303 may be controlled. This can be implemented by, for example, changing the current amounts to the gates of the FET components in the above-described H bridge circuit that can be employed as the voltage switching circuit 405. For example, the current amounts to the gates of the FET components may be decreased by 20% from the initial state in S1005, increased by 10% from the initial state in S1007, increased by 10% from the state of S1007 in S1010, and increased by 10% from the state of S1010 in S1013.

Note that the above-described several modifications may be combined, and the change of the voltage value to be input to the piezoelectric element 303 and the change of the times of the rise edge and the fall edge of its waveform may be used together.

### Second Embodiment

In the above-described first embodiment, a mode in which the circulation frequency is adjusted by detecting the discharge speed of the ink droplet 707 when executing print has been exemplified. However, the adjustment of the circulation frequency may be performed at another timing. The adjustment of the circulation frequency may be performed, for example, based on the time counting result of an internal timer (not shown) when a printing apparatus 100 is in a standby mode (a state in which a print job is being accepted) or a sleep mode (a state of power saving), or can be performed based on satisfaction of various conditions.

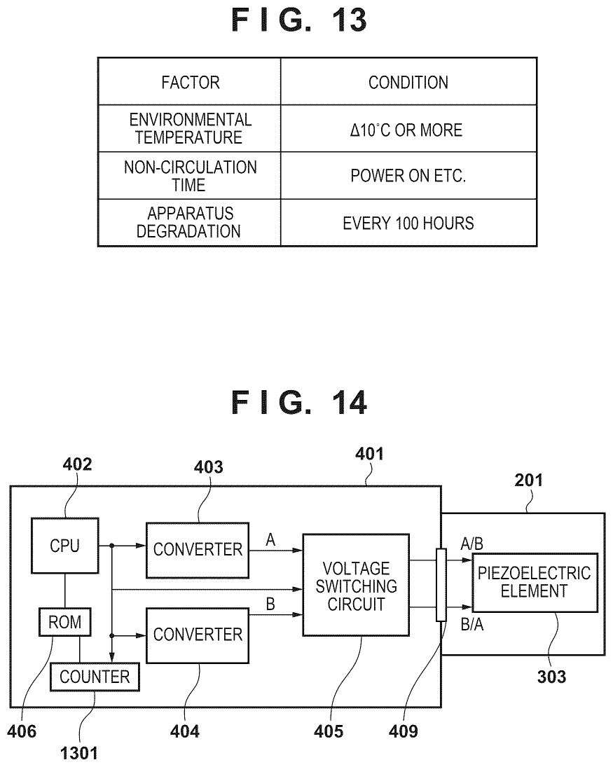

FIG. 13 shows the execution conditions of circulation frequency adjustment and, more specifically, factors associated with the ink viscosity and corresponding conditions of timings of execution of the adjustment of the circulation frequency. The ink viscosity varies depending on, for example, an environmental temperature, a non-circulation time, and a degree of apparatus degradation (mainly the degree of degradation of a piezoelectric element 303). Hence, for the individual factors associated with the ink viscosity, the conditions of timings to execute adjustment of the circulation frequency are preferably provided.

For example, as for the environmental temperature, a case where the environmental temperature changes more than a reference since the past circulation frequency adjustment, a case where the temperature changes by 10° C. or more, or the like can be set as the execution condition. As for the non-circulation time, a case where the printing apparatus 100 is activated/powered on, a case where the elapsed time after that meets a criterion, or the like can be set as the execution condition. Also, as for the degree of apparatus degradation, a case where the cumulative time of the print operation meets a criterion, a case where the print operation is performed for 100 hrs from preceding circulation frequency adjustment, or the like can be set as the execution condition. Note that the above-described non-circulation time, elapsed time, and cumulative time can be measured by an internal timer.

If one of the above-described conditions is satisfied, the circulation frequency is adjusted in accordance with the same procedure as in FIGS. 12A and 12B and, at that time, the circulation frequency may be increased/decreased at a magnification different from the above-described first embodiment. For example, the circulation frequency can be changed to 1.2 times in S1010 and to 1.5 times in S1013.

For example, when the environmental temperature (preceding environmental temperature) in preceding circulation frequency adjustment is stored in a ROM 406, the circulation frequency adjustment can be executed if the environmental temperature detected by a temperature sensor 111 changes by 10° C. or more from the preceding environmental temperature.

As another example, as for the non-circulation time, during activation of the printing apparatus 100, the circulation frequency can periodically be adjusted when the elapsed time meets the criterion. However, if the printing apparatus 100 is stopped/powered off, the circulation frequency is not adjusted. Hence, if the printing apparatus 100 is activated again after that, the circulation frequency is adjusted.

As still another example, it is considered that if the piezoelectric element 303 degrades, energy necessary for ink circulation cannot sufficiently be obtained. In this case, as shown in FIG. 14, a counter 1301 configured to measure the cumulative drive time of the piezoelectric element 303 is provided on the control substrate 401, and the circulation frequency is adjusted when the cumulative drive time meets a criterion. This can be implemented by storing the measurement result of the counter 1301 in the ROM 406. Note that if a plurality of piezoelectric elements 303 are used, the cumulative drive time is measured for each piezoelectric element 303, and the circulation frequency is adjusted when one of the measurement results meets a criterion.

According to this embodiment, the adjustment of the circulation frequency is performed when one of several conditions is satisfied, for each color, the discharge speed of the ink droplet 707 is stabilized such that it falls within the reference range, and the quality of print can further be improved.

As in the above-described first embodiment, the circulation frequency adjustment according to this embodiment can be performed for one color and, after that, the adjusted circulation frequency can be applied to the remaining colors. However, the adjustment of the circulation frequency may be performed for each color (individually).

### Third Embodiment

FIG. 11C shows the relationship between a circulation frequency that is set such that the discharge speed of an ink droplet 707 falls within a reference range and the elapsed time when a piezoelectric element 303 is continuously driven. An increase of the elapsed time corresponds to the progress of aging of the piezoelectric element 303. If the elapsed time is long, the displacement amount of the piezoelectric element 303 decreases, and the ink stirring efficiency decreases and, therefore, the ink viscosity on the periphery of a nozzle 304 becomes high. Hence, the circulation frequency reaches a set upper limit value along with the elapse of time while being feedback-controlled such that it approaches a target value indicated by a broken line. Hence, in the third embodiment, ink circulation control is performed in consideration of this.

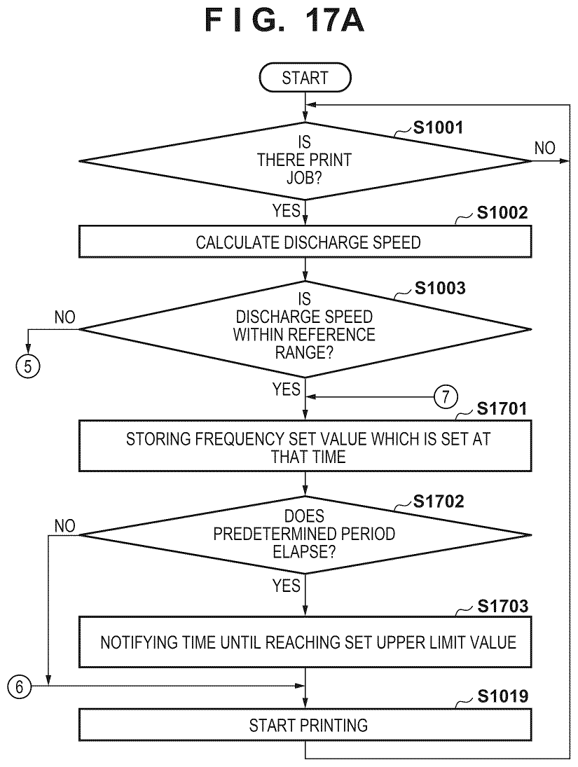

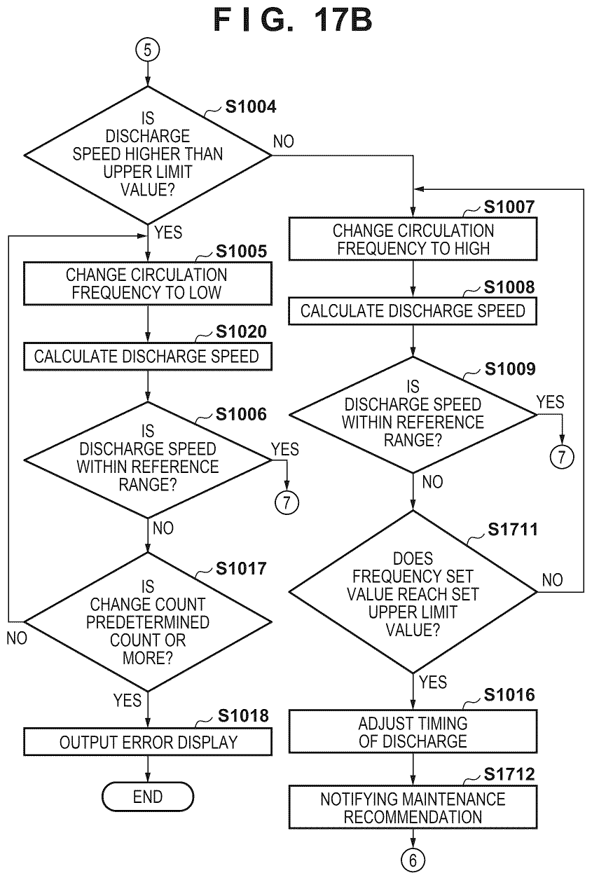

FIGS. 17A and 17B is a flowchart showing an ink circulation control method according to this embodiment. Note that a description of the same contents (S1001 to S1009 and S1016 to S1020) as the steps described above with reference to FIGS. 12A and 12B will be omitted.

In S1701 (upon determining in S1003 that the discharge speed of the ink droplet 707 falls within the reference range), the set value of the circulation frequency at that time/that is set is stored in a ROM 406. After that, in S1702, it is determined whether a predetermined period elapses from the start of use of a printing apparatus 100. If a predetermined period elapses, the process advances to S1703 and, otherwise, the process advances to S1019.

In S1703, a history (a history stored in the ROM 406) of the circulation frequency till then is referred to, the time until the circulation frequency reaches a set upper limit value is calculated based on, for example, an approximate curve calculated using a known formula, and the result is notified to the user. The set upper limit value here is an upper limit value that can be set for the circulation frequency, and need only be specified and set in advance by an evaluation test or the like.

In S1711 (upon determining in S1009 that the discharge speed falls within the reference range), it is determined whether the circulation frequency reaches the set upper limit value. If the circulation frequency reaches the set upper limit value, the process advances to S1016 and, otherwise, the process returns to S1007.

Also, after discharge timing adjustment is performed in S1016 and before print is started in S1019, in S1712, a notification to recommend maintenance is made to the user. The maintenance here is typically exchange of a constituent component (a printhead 201, a circulation mechanism, or the like) of the printing apparatus 100 but may be repair of a component by the user himself/herself or a service person.

According to this embodiment, if a predetermined period elapses from the start of use of the printing apparatus 100, the time until the circulation frequency reaches the set upper limit value is notified. If the circulation frequency reaches the set upper limit value, recommendation of maintenance is notified before the production efficiency of print lowers due to discharge timing adjustment. Hence, according to this embodiment, the same effect as in the above-described first embodiment can be obtained, and a planned operation of the printing apparatus 100 by the user, such as preparation of an exchange component (for example, the printhead 201) can be implemented.

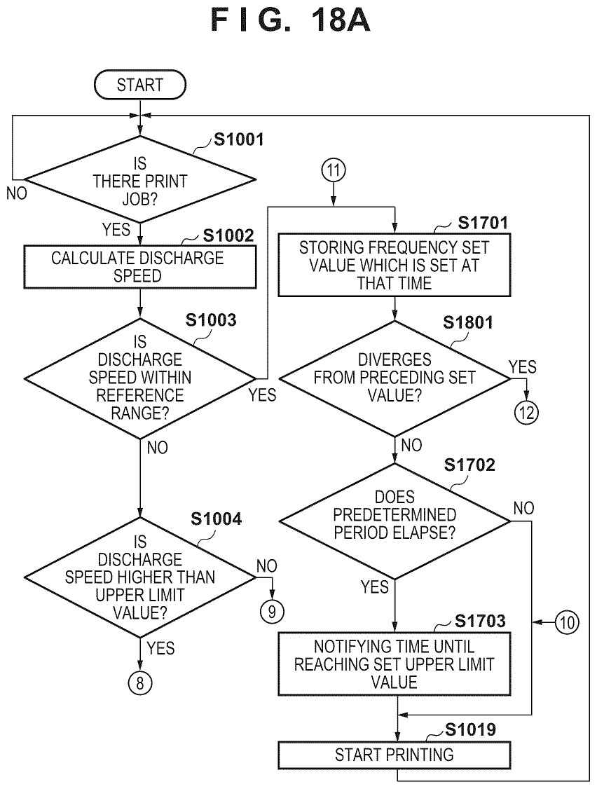

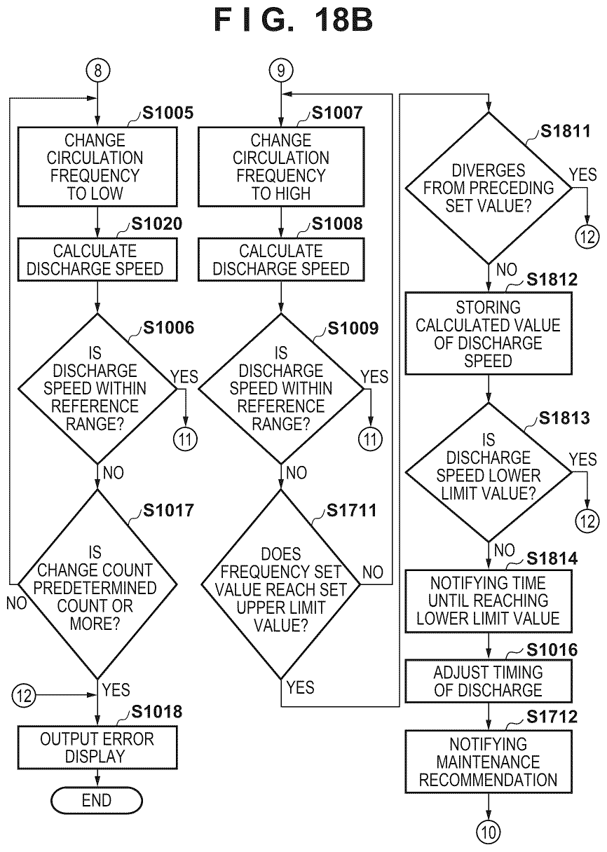

FIGS. 18A and 18B is a flowchart showing a method according to an example of the modification of this embodiment, and further steps are executed based on whether the change of the setting of the circulation frequency falls within an allowable range.

After the set circulation frequency is stored in a ROM 406 in S1701 and before it is determined in S1702 whether a predetermined period elapses, in S1801, it is determined whether the set value of the circulation frequency diverges from the preceding set value more than a reference. If the set value of the circulation frequency diverges more than a reference, the process advances to S1018 and, otherwise, the process advances to S1702. The divergence more than a reference here indicates that the difference between the set value at that time and the preceding set value falls outside an allowable range.

Similarly, after it is determined in S1711 that the circulation frequency reaches the set upper limit value and before discharge timing adjustment is performed in S1016, in S1811, it is determined whether the set value of the circulation frequency diverges from the preceding set value more than a reference. If the set value of the circulation frequency diverges more than a reference, the process advances to S1018 and, otherwise, the process advances to S1812.

After that in S1812, the calculated value of the discharge speed of the ink droplet 707 is stored in the ROM 406.

In S1813, it is determined whether the calculated value of the discharge speed is less than a lower limit value. If the calculated value of the discharge speed is less than the lower limit value, the process advances to S1018 and, otherwise, the process advances to S1814.

In S1814, a calculation history (a history stored in the ROM 406) of the discharge speed till then is referred to, time until the discharge speed reaches the lower limit value is calculated based on, for example, an approximate curve calculated using a known formula, and the result is notified to the user.

According to this modification, if the change of the setting of the circulation frequency falls outside the allowable range, error display is output. Even if the change falls within the allowable range, time until maintenance is notified to the user. The user can thus prepare an exchange component (for example, the printhead 201) in advance for maintenance, and a further planned operation of the printing apparatus 100 by the user can be implemented.

Note that in the first to third embodiments, as a means for setting the discharge speed of the ink droplet 707 within the reference range, a mode in which the circulation frequency is adjusted has been exemplified. It is only necessary to control the drive force for circulating ink, and it may be implemented by another means. That is, the circulation flow amount of ink may be controlled, and as an example, the opening of a predetermined valve that can be arranged at an arbitrary position in the circulation path may be adjusted or controlled.

### Program

The present disclosure may be implemented by supplying a program that implements one or more functions of the above-described embodiments to a system or an apparatus via a network or a storage medium and reading out the program by one or more processors in the computer of the system or the apparatus and executing it. For example, the present disclosure may be implemented by a circuit (for example, an ASIC) that implements one or more functions.

### Others

In the embodiments, each element is named by an expression based on its main function, but the function described in the embodiments may be a sub function, and the expression is not strictly limited. Also, the expression can be replaced with another expression.

Also, two or more elements selectably exemplified in the embodiments are not strictly limited to the exemplification and may be combined arbitrarily. For example, each of the two or more exemplified elements may be additionally selected or alternatively selected. As an example, when arbitrarily combining two elements A and B, an expression “A and/or B” or an expression “at least one of A and B” may be used to indicate only A, only B, or both A and B.

In addition, the expressions of a reference, a reference value, an allowance, an upper limit value, a lower limit value, an allowable range, and the like are set in advance for comparison with a target. These may be replaced with other expressions for the sake of discrimination, or “first”, “second”, and the like may be added for the sake of discrimination.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-224303, filed Dec. 19, 2024, and Japanese Patent Application No. 2025-065780, filed Apr. 11, 2025, which are hereby incorporated by reference herein in their entirety.

What is claimed is:

1. A printing apparatus comprising:
a printhead configured to perform print by discharging ink; and
a circulation mechanism configured to circulate the ink in a circulation path of ink, which passes through the printhead, wherein
the printing apparatus further comprises:
a specifying unit configured to specify a discharge speed of an ink droplet from the printhead; and
a control unit configured to perform drive control of the circulation mechanism based on a specifying result of the specifying unit.

2. The apparatus according to claim 1, wherein
the control unit performs the drive control of the circulation mechanism such that the discharge speed specified by the specifying unit falls within a reference range.

3. The apparatus according to claim 2, wherein
the control unit changes a drive force for circulating the ink such that the discharge speed specified by the specifying unit falls within the reference range.

4. The apparatus according to claim 3, wherein
the control unit performs the change of the drive force a predetermined number of times, and
the printing apparatus further comprises a notification unit configured to, if the change of the drive force is performed the predetermined number of times, notify that the change of the drive force is performed the predetermined number of times.

5. The apparatus according to claim 1, wherein
the circulation mechanism includes a circulation pump arranged in the circulation path, and
the control unit changes a drive frequency of the circulation pump.

6. The apparatus according to claim 5, wherein
the control unit further changes a duty cycle of a drive signal of the circulation pump.

7. The apparatus according to claim 1, wherein
the circulation mechanism includes a circulation pump arranged in the circulation path, and
the control unit changes a duty cycle of a drive signal of the circulation pump.

8. The apparatus according to claim 1, wherein
the circulation mechanism includes a circulation pump arranged in the circulation path, and
the control unit changes a voltage value of a drive signal of the circulation pump.

9. The apparatus according to claim 1, wherein
the circulation mechanism includes a circulation pump arranged in the circulation path, and
the control unit changes times of a rise edge and a fall edge of a drive signal of the circulation pump.

10. The apparatus according to claim 1, further comprising:
a storage unit configured to store a history of the drive control of the circulation mechanism by the control unit based on the specifying result of the specifying unit; and
a notification unit configured to notify a user of time of maintenance based on the history stored in the storage unit.

11. The apparatus according to claim 10, further comprising
a calculation unit configured to calculate an approximate curve of a set value concerning the drive control of the circulation mechanism based on the history stored in the storage unit and calculate time until the approximate curve reaches an upper limit value of the set value.

12. The apparatus according to claim 10, wherein
the storage unit further stores, as a second history, a history of the discharge speed specified by the specifying unit after a set value concerning the drive control of the circulation mechanism reaches an upper limit value of the set value, and
the notification unit notifies the time of maintenance based on the second history stored in the storage unit.

13. The apparatus according to claim 10, wherein
the control unit performs the drive control of the circulation mechanism such that the discharge speed specified by the specifying unit falls within a reference range, and
if the discharge speed does not fall within the reference range and the discharge speed diverges more than a reference, the notification unit notifies that maintenance is necessary.

14. The apparatus according to claim 1, wherein
the printhead performs print by discharging inks of a plurality of colors,
the circulation mechanism and the circulation path are provided for each color of ink,
the specifying unit specifies the discharge speed for each color of ink, and
the control unit performs the drive control of the circulation mechanism for each color of ink.

15. The apparatus according to claim 1, wherein
the printhead performs print by discharging inks of a plurality of colors,
the circulation mechanism and the circulation path are provided for each color of ink,
the specifying unit specifies the discharge speed for a certain color of ink, and
the control unit performs the drive control of the circulation mechanism for each of the plurality of colors based on the specifying result of the specifying unit.

16. The apparatus according to claim 1, further comprising
an acceptance unit configured to accept a print job for instructing execution of print,
wherein the specifying unit specifies the discharge speed when the acceptance unit accepts the print job.

17. The apparatus according to claim 1, further comprising
a detection unit configured to detect an environmental temperature,
wherein the specifying unit specifies the discharge speed based on a detection result of the detection unit.

18. The apparatus according to claim 1, further comprising
a time counting unit,
wherein the specifying unit specifies the discharge speed based on a time counting result of the time counting unit.

19. The apparatus according to claim 1, wherein the specifying unit includes an optical sensor.

20. The apparatus according to claim 1, wherein the specifying unit includes an electrostatic sensor.

21. The apparatus according to claim 1, wherein
the printhead is a serial head, and
the specifying unit specifies the discharge speed based on a pattern printed by print scan of the serial head.

22. A non-transitory computer-readable storage medium storing a program configured to cause a computer to function as each unit of a printing apparatus defined in claim 1.

23. A driving method of a printing apparatus comprising a printhead configured to perform print by discharging ink, and a circulation mechanism configured to circulate the ink in a circulation path of ink, which passes through the printhead, comprising:
specifying a discharge speed of an ink droplet from the printhead; and
performing drive control of the circulation mechanism based on the specified discharge speed.
